(19) United States
(12) Patent Application Publication
(10) Pub. No.: US 2010/0124906 A1
(43) Pub. Date: May 20, 2010

(54) Method and Apparatus for Transmitting and Receiving Data

(75) Inventor: Ismo Hautala, Espoo (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/271,670

(22) Filed: Nov. 14, 2008

(51) Int. Cl. H04M 3/42

(52) U.S. Cl. 455/412.1

(57) ABSTRACT

In accordance with an example embodiment of the present invention, an apparatus comprising a data browse configured to display data. Further, the apparatus comprises a common share area configured to receive data. The apparatus also comprises a processor configured to allow selection of data from the data browse using the common share area. The common share area is also configured to receive the selected data. Further, the processor is configured to transmit the selected data from the common share area to a contact. The common share area is also configured to display previously and currently transmitted data associated with the contact.

### TECHNICAL FIELD

The present application relates generally to transmitting and receiving data.

### BACKGROUND

A user may use an electronic device to communicate with friends, family, or other types of contacts. Further, the electronic device may provide a user with communication features. As such, the electronic device facilitates communication.

### SUMMARY

Various aspects of examples of the invention are set out in the claims.

According to a first aspect of the present invention, an apparatus comprising a data browse configured to display data. Further, the apparatus comprises a common share area configured to receive data. The apparatus also comprises a processor configured to allow selection of data from the data browse using the common share area. The common share area is also configured to receive the selected data. Further, the processor is configured to transmit the selected data from the common share area to a contact. The common share area is also configured to display previously and currently transmitted data associated with the contact.

According to a second aspect of the present invention, a method comprises allowing selection of data from a data browse using the common share area, receiving the selected data in the common share area, transmitting the selected data from the common share area to a contact; and displaying previously and currently transmitted data associated with the contact in the common share area.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting an electronic device operating in accordance with an example embodiment of the invention;

FIG. 2A is a block diagram depicting an electronic device and another electronic device operating in accordance with an example embodiment of the invention;

FIG. 2B is a block diagram depicting a more detailed view of the electronic device of FIG. 2A operating in accordance with an example embodiment of the invention;

FIG. 3A is a flow diagram depicting an example method for transmitting and receiving data in accordance with an example embodiment of the invention;

FIG. 3B is a flow diagram depicting another example method for transmitting and receiving data in accordance with an example embodiment of the invention;

FIG. 4A depicts an electronic device sharing a data view of data in accordance with an example embodiment of the invention;

FIG. 4B depicts an electronic device sharing a chronological view of data in accordance with an example embodiment of the invention; and

FIG. 4C depicts an electronic device sharing a chat view of data in accordance with an example embodiment of the invention.

### DETAILED DESCRIPTION OF THE DRAWINGS

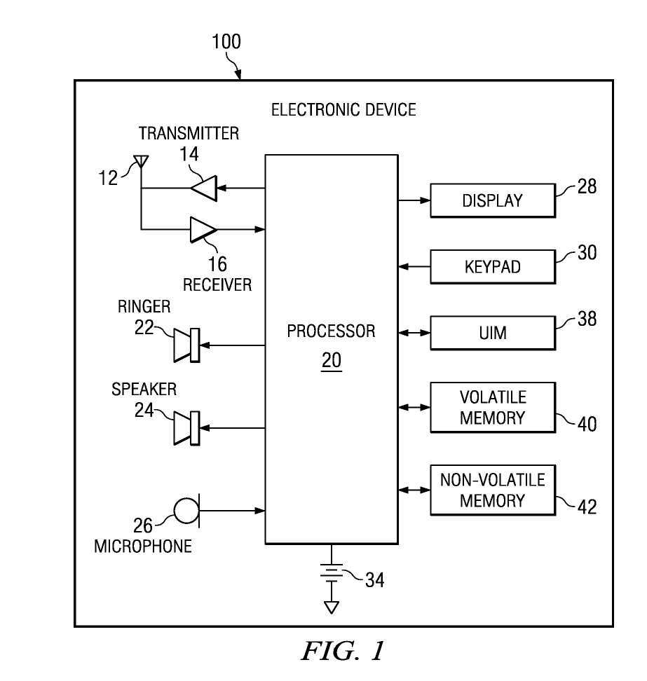

An example embodiment of the present invention and its potential advantages are best understood by referring to FIGS. 1 through 4C of the drawings.

FIG. 1 is a block diagram depicting an electronic device 100 operating in accordance with an example embodiment of the invention. In an example embodiment, an electronic device 100 comprises at least one antenna 12 in communication with a transmitter 14, a receiver 16, and/or the like. The electronic device 100 may further comprise a processor 20 or other processing component. The processor 20 may provide at least one signal to the transmitter 14 and may receive at least one signal from the receiver 16. In an embodiment, the electronic device 100 also comprises a user interface comprising one or more input or output devices, such as a conventional earphone or speaker 24, a ringer 22, a microphone 26, a display 28, and/or the like. In an embodiment, the one or more output devices of the user interface are coupled to the processor 20.

In an example embodiment, the user interface allows the electronic device 100 to receive or transmit data. For example, the user interface comprises any of a number of devices configured to receive data, such as a keypad 30, a touch display, other input device, and/or the like. In an embodiment, the keypad 30 comprises the conventional numeric, e.g., 0-9, and/or related keys, e.g., #, *, other hard and/or soft keys, and/or the like to operate the electronic device 100. In an alternative embodiment, the keypad 30 comprises a conventional QWERTY keypad arrangement. Further, the keypad 30 may also comprise various soft keys with associated features. If desired, the electronic device 100 may comprise a user interface device, such as a joystick or the like.

In an embodiment, the electronic device 100 also comprises a battery 34, such as a vibrating battery pack, for powering various circuits to operate the electronic device 100. Further, the vibrating battery pack may also provide mechanical vibration as a detectable output. In an embodiment, the electronic device 100 further comprises a user identity module (UIM) 38. In one embodiment, the UIM 38 is a memory device comprising a processor. The UIM 38 may comprise, for example, a subscriber identity module (SIM), a universal integrated circuit card (UICC), a universal subscriber identity module (USIM), a removable user identity module (R-UIM), and/or the like. Further, the UIM 38 may store one or more information elements related to a subscriber, such as a mobile subscriber.

In an embodiment, the electronic device 100 comprises memory. For example, the electronic device 100 may comprise volatile memory 40, such as random access memory (RAM). Volatile memory 40 may comprise a cache area for the temporary storage of data. Further, the electronic device 100 may also comprise non-volatile memory 42, which may be embedded and/or may be removable. The non-volatile memory 42 may also comprise an electrically erasable programmable read only memory (EEPROM), flash memory, and/or the like. In an alternative embodiment, the processor 20 comprises memory. For example, the processor 20 may comprise volatile memory 40, non-volatile memory 42, and/or the like.

In an embodiment, the electronic device 100 uses memory to store any of a number of pieces of information and/or data to implement one or more features of the electronic device 100. Further, the memory may comprise an identifier, such as international mobile equipment identification (IMEI) code, capable of uniquely identifying the electronic device 100. The memory may store one or more instructions for determining cellular identification information based at least in part on the identifier. For example, the processor 20, using the stored instructions, may determine an identity, e.g., cellular identification identity or cellular identification information, of a communication with the electronic device 100.

In an embodiment, the processor 20 of the electronic device 100 comprises circuitry for implementing audio feature, logic features, and/or the like. For example, the processor 20 may comprise a digital signal processor device, a microprocessor device, a digital to analog converter, other support circuits, and/or the like. In an embodiment, control and signal processing features of the processor 20 are allocated between devices, such as the devices describe above, according to their respective capabilities. Further, the processor 20 may also comprise an internal voice coder and/or an internal data modem. Further still, the processor 20 may comprise features to operate one or more software programs. For example, the processor 20 may be capable of operating a software program for connectivity, such as a conventional Internet browser. Further, the connectivity program may allow the electronic device 100 to transmit and receive Internet content, such as location-based content, other web page content, and/or the like. In an embodiment, the electronic device 100 uses a wireless application protocol (WAP), hypertext transfer protocol (HTTP), file transfer protocol (FTP) and/or the like to transmit and/or receive the Internet content.

In an embodiment, the electronic device 100 is capable of operating in accordance with any of a number of a first generation communication protocol, a second generation communication protocol, a third generation communication protocol, a fourth generation communication protocol, and/or the like. For example, the electronic device 100 may be capable of operating in accordance with second generation (2G) communication protocols IS-136, time division multiple access (TDMA), global system for mobile communication (GSM), IS-95 code division multiple access (CDMA), and/or the like. Further, the electronic device 100 may be capable of operating in accordance with third-generation (3G) communication protocols, such as Universal Mobile Telecommunications System (UMTS), CDMA2000, wideband CDMA (WCDMA), time division-synchronous CDMA (TD-SCDMA), and/or the like. Further still, the electronic device 100 may also be capable of operating in accordance with 3.9 generation (3.9G) wireless communication protocols, such as Evolved Universal Terrestrial Radio Access Network (E-UTRAN) or the like, or wireless communication projects, such as long term evolution (LTE) or the like. Still further, the electronic device 100 may be capable of operating in accordance with fourth generation (4G) communication protocols.

In an alternative embodiment, the electronic device 100 is capable of operating in accordance with a non-cellular communication mechanism. For example, the electronic device 100 may be capable of communication in a wireless local area network (WLAN), other communication networks, and/or the like. Further, the electronic device 100 may communicate in accordance with techniques, such as radio frequency (RF), infrared (IrDA), any of a number of WLAN techniques. For example, the electronic device 100 may communicate using one or more of the following WLAN techniques: IEEE 802.11, e.g., 802.11a, 802.11b, 802.11g, 802.11n, and/or the like. Further, the electronic device 100 may also communicate, via a world interoperability, to use a microwave access (WiMAX) technique, such as IEEE 802.16, and/or a wireless personal area network (WPAN) technique, such as IEEE 802.15, BlueTooth (BT), ultra wideband (UWB), and/or the like.

It should be understood that the communications protocols described above may employ the use of signals. In an example embodiment, the signals comprise signaling information in accordance with the air interface standard of the applicable cellular system, user speech, received data, user generated data, and/or the like. In an embodiment, the electronic device 100 is capable of operating with one or more air interface standards, communication protocols, modulation types, access types, and/or the like. It should be further understood that the electronic device 100 is merely illustrative of one type of electronic device that would benefit from embodiments and, therefore, should not be taken to limit the scope of embodiments.

While embodiments of the electronic device 100 are illustrated and will be hereinafter described for purposes of example, other types of electronic devices, such as a portable digital assistant (PDA), a pager, a mobile television, a gaming device, a camera, a video recorder, an audio player, a video player, a radio, a mobile telephone, a traditional computer, a portable computer device, a global positioning system (GPS) device, a GPS navigation device, a GPS system, a mobile computer, a browsing device, an electronic book reader, a combination thereof, and/or the like, may be used. While several embodiments of the invention may be performed or used by the electronic device 100, embodiments are also be employed by a server, a service, a combination thereof, and/or the like.

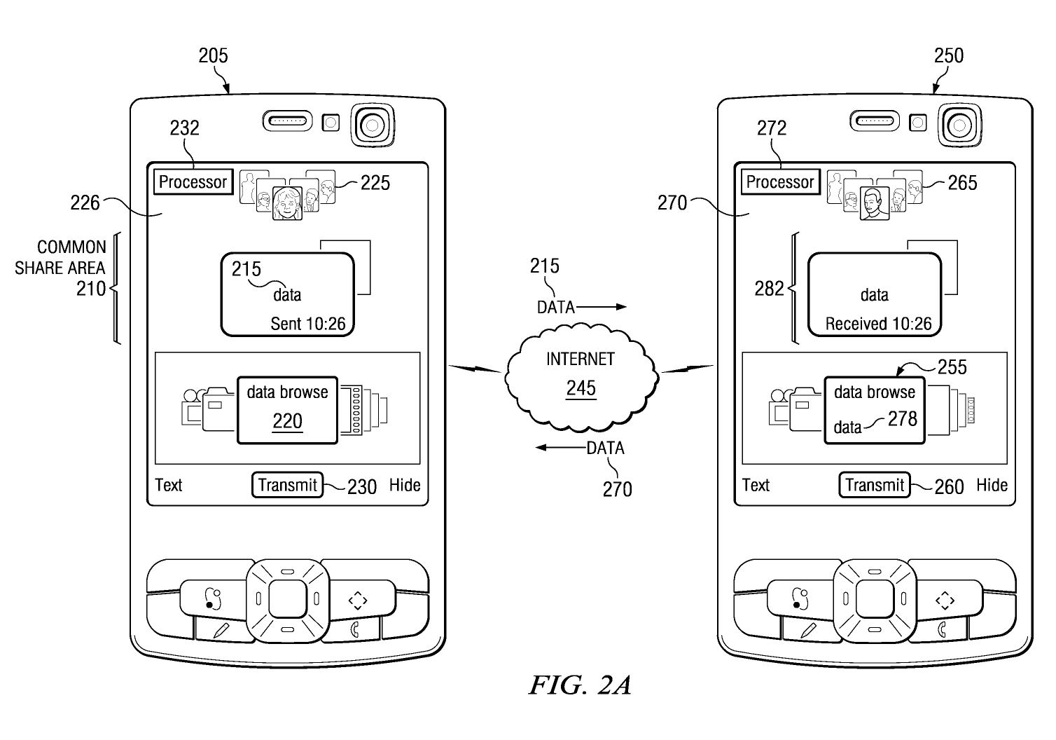

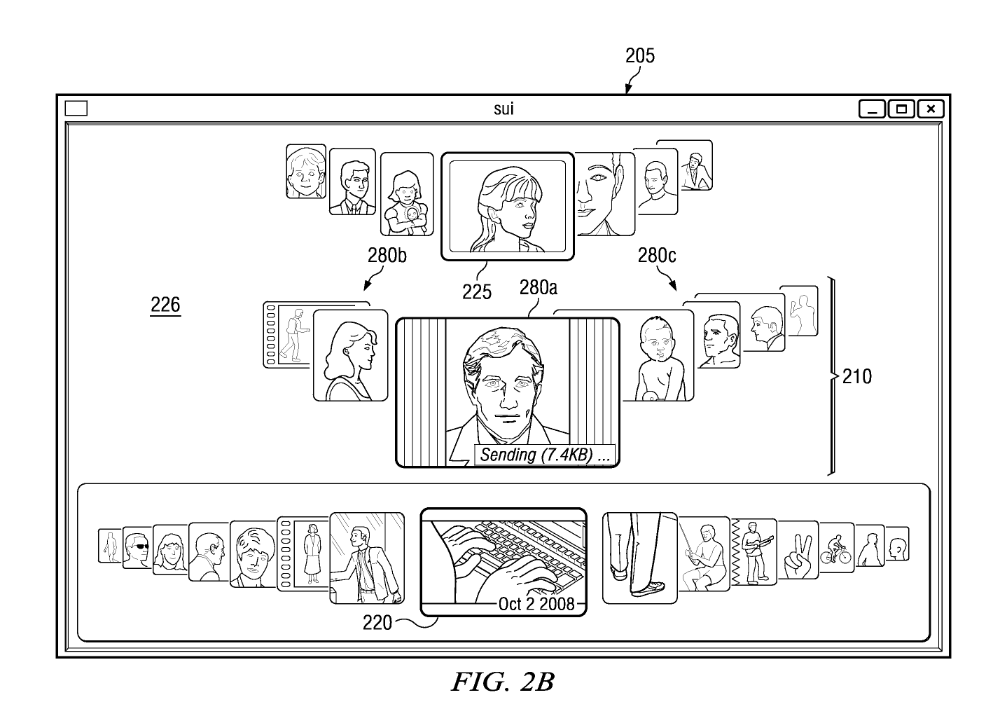

FIG. 2A is a block diagram depicting an electronic device 205 and another electronic device 250 operating in accordance with an example embodiment of the invention. In an embodiment, the electronic device 205 comprises a processor 232 and/or a user interface 226. In an example embodiment, the electronic device 205 is similar to electronic device 100 of FIG. 1 and the processor 232 is similar to the processor 20 of FIG. 1. In an alternative embodiment, the electronic device 205 is different than electronic device 100 of FIG. 1 and the processor 232 is different than the processor 20 of FIG. 1.

In an example embodiment, the electronic device 250 comprises a processor 272 and/or a user interface 270. In an example embodiment, the electronic device 250 is similar to electronic device 100 of FIG. 1 and the processor 272 is similar to the processor 20 of FIG. 1. In an alternative embodiment, the electronic device 250 is different than electronic device 100 of FIG. 1 and the processor 272 is different than the processor 20 of FIG. 1.

In an example embodiment, the electronic device 205 and another electronic device 250 are configured to establish a connection with, for example, a contact, such as contacts 225, 265. In an embodiment, the connection is at least one of the following: a voice call, an instant message, a voice over Internet protocol call, a short message service, multimedia messaging service, and/or the like. In an embodiment, the electronic device 205 and/or another electronic device 250 establishes the connection via a network, such as Internet 245. In an alternative embodiment, an active connection, e.g., an active voice call, exists between the electronic device 205 and another electronic device 250. In such a case, no further connection is established.

In an example embodiment, the processor 232 of the electronic device 205 is configured to allow selection of data from a data browse 220. In an example embodiment, the data browse 220 is a screen area which allows a user to find and/or view data, such as data 215, on the electronic device 205. In an example embodiment, the user interface 226 is configured to display the data, such as data 215, for selection in the data browse 220. The data 215 may comprise one or more types of data. In an embodiment, one or more types of data relates to at least one of the following: an audio file, a live audio feed, a document, a text message, a video file, a live video feed, a single character, a single music note, and/or the like.

In an example embodiment, the user interface 226 displays a common share area 210. In an embodiment, the common share area 210 is capable of receiving data, such as data 215. In an embodiment, the user interface 226 allows a user to drag data 215 from the data browse 220 to the common share area 210. For example, a user drags an image of an automobile from the data browse 220 to the common share area 210. It should be understood that transferring the data 215 from the data browse 220 to the common share area 210 is not limited to drag and drop and any number of techniques may be employed to transfer data 215.

In an embodiment, the user interface 226 displays a transmit button 230 to initiate data 215 transfer. For example, a user may press the transmit button 230 to transmit the image of the automobile to another electronic device 250. In an embodiment, the processor 232 transmits the selected data, e.g., data 215, in the common share area 210 to the contact 225, e.g., a contact related to another electronic device 250, via the connection, e.g., an active call. In an alternative embodiment, the processor 232 transmits the data 215 in the common share area 210 to a server, service, and/or the like. In an embodiment, the processor 232 is configured to transmit data and receive data simultaneously.

In an example embodiment, the electronic device 250 is configured to receive data 215, via the Internet 245, in a common share area 282 from, for example, electronic device 205. In an embodiment, the user interface 270 is configured to display the data 215 received in the common share area 282. For example, a user of electronic device 250 may view a received image of an automobile. In an embodiment, the user interface 270 is configured to display the data 215 received in at least one of the following views: a chronological view, a data view, a chat view, and/or the like. In an example embodiment, the chronological view displays the data 215 in the order of receipt. In an example embodiment, the data view displays the data 215 and a chat conversation, for example, with a user of another electronic device in real time. In an example embodiment, the chat view displays the data 215, e.g., received a received image and/or a text message.

In an embodiment, the user interface 270 of electronic device 250 is configured to display a data browse 255. In an embodiment, the data browse 255 comprises data 278. Further, the data browse may be configured to display data 278 on the electronic device 250. In an embodiment, data 278 relates to at least one of the following: an audio file, a live audio feed, a document, a text message, a video file, a live video feed, and/or the like. In an embodiment, the processor 272 of the electronic device 250 is configured to allow selection of data, such as data 215. For example, data 278 may be dragged and dropped on the common share area 282.

In an embodiment, the user interface 270 displays a transmit button 260. For example, a user may press the transmit button 260 to transmit a live camera feed to electronic device 205. In an embodiment, the processor 272 of the electronic device 250 is configured to transmit data, such as data 215, to a contact 265 of the electronic device 205. In an embodiment, the processor 272 transmits the data 278, e.g., the selected data, in the common share area 282 to the contact 265, e.g., a contact for electronic device 205, via the connection, e.g., an active call.

In an embodiment, the common share area 210 of the electronic device 205 is configured to receive the data 278 from the electronic device 250. For example, the electronic device 205 may receive the live camera feed from the electronic device 250. In an embodiment, the user interface 226 is configured to display the received data in at least one of the following views: a chronological view, a data view, and/or a chat view. In an embodiment, the processor 272 is configured to transmit data and receive data simultaneously.

Consider the following example. A user of electronic device 205 selects a contact 225 to transmit data to. Further, the user selects a video by touching the video. The user may also send the video by dragging the video from the data browse 220 into the common share area 210. The user of electronic device 250 receives the video in the common share area 282. The user of electronic device 250 may view the video and/or transmit the video to another user using contacts 265. If desired, the user of electronic device 250 may transmit data simultaneously or separately to the electronic device 205 in a similar manner as described above with regard to electronic device 205. For example, the user of electronic device 250 may transmit a text message in response to the received data. Alternatively, the user of electronic device 250 may transmit an image in response to the received data. Other transmissions are also possible.

FIG. 2B is a block diagram depicting a more detailed view of the electronic device 205 of FIG. 2A operating in accordance with an example embodiment of the invention. In an example embodiment, the electronic device 205 comprises a user interface 226. Further, the user interface 226 is configured to display a contact 225, a common share area 210 and a data browse 220. In an embodiment, the common share area 210 is configured to receive data from the data browse 220. In an example embodiment, the data browse 220 is a screen area which allows a user to find and/or view data, such as data 215, on the electronic device 205.

In an embodiment, the user interface 226 allows a user to drag data from the data browse 220 to the common share area 210. For example, a user drags an image of piano player from the data browse 220 to the common share area 210. The user may transmit the data from the common share area 210 to another electronic device, server, service, and/or the like according to an example embodiment.

In an embodiment, the common share area 210 displays currently transmitted data 280a and previously transmitted data 280b, 280c associated with the contact in the common share area 210. In an embodiment, the user interface 226 allows a user to browse the common share area 210 to view data transferred to and/or received from the contact 225. For example, a user views all of the images and videos previously and currently transferred to or from a friend. A possible technical effect of one or more of the example embodiments disclosed herein is viewing previous and current data transfers for a contact.

In an example embodiment, the data browse 220 comprises any number of types of data. In an embodiment, the data comprises a thumbnail and/or a string representation. In an embodiment, the string relates to a contact, a photo, a video, a song, a music album, a movie, a calendar event, a single character, a musical note, and/or the like. In an embodiment, the data browse 220 accesses an application to obtain data associated with the thumbnail and/or string representation. For example, the data browse 220 accesses a software program to obtain the image associated with a thumbnail.

In an example embodiment, the data browse 220 displays the data to a user. For example, the data browse 200 displays thumbnails to a user. In an embodiment, the data browse 220 is configured to switch the data to be displayed. For example, the data browse allows a user to switch the displayed data from images to videos. It should be understood that the common share area 210 is also capable to switching the displayed data.

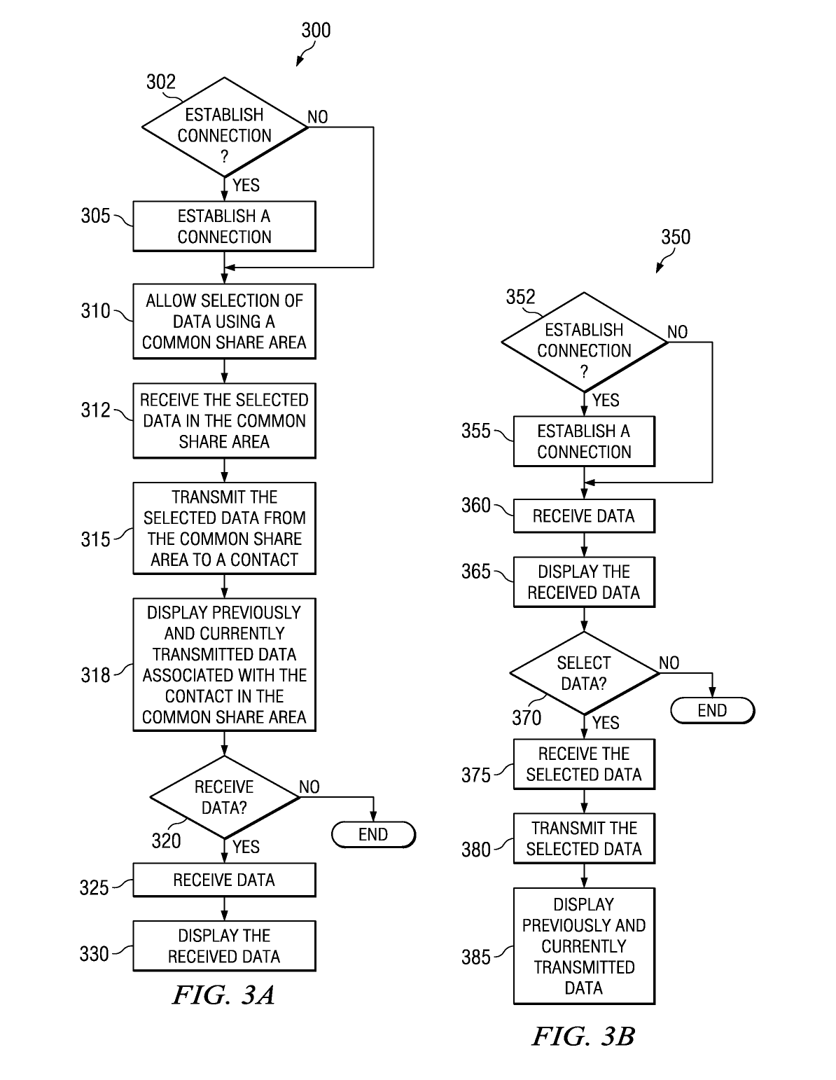

FIG. 3A is a flow diagram depicting an example method 300 for transmitting and receiving data in accordance with an example embodiment of the invention. Example method 300 may be performed by an electronic device, such as electronic device 205 of FIG. 2A.

At 302, it is determined whether a connection is to be established. In an example embodiment, a first electronic device, such as electronic device 205 of FIG. 2A, and a second electronic device, such as electronic device 250 of FIG. 2A, establish a connection if an active connection between the electronic devices does not already exist.

If at 302 it is determined that a connection is to be established, then at 305 a connection is established. In an example embodiment, the first electronic device and a second electronic device establish a connection. In an embodiment, the connection is at least one of the following: a voice call, an instant message, a voice over Internet protocol call, a short message service, multimedia messaging service, and/or the like. In an embodiment, the first electronic device and/or second electronic device establish the connection via a network, such as Internet 245 of FIG. 2A. The example method 300 continues at 310.

If at 302, it is determined that a connection is not to be established, the example method 300 continues at 310.

At 310, selection of data is allowed. In an example embodiment, a processor, such as processor 232, allows selection of data, such as data 215 of FIG. 2A, using a common share area, such as common share area 210 of FIG. 2A. For example, a user of the first electronic device drags data from, for example, a data browse, such as data browse 220 of FIG. 2A, to the common share area. In an embodiment, the data comprises one or more types of data.

At 312, the selected data is received in the common share area. In an example embodiment, the common share area is configured to receive the selected data from the data browse. A user, for example, drags an image from the data browse, which is received by the common share area.

At 315, the selected data is transmitted from the common share area to a contact. In an example embodiment, the processor of the first electronic device transmits the selected data in the common share area to a second electronic device. In an embodiment, a user interface, such as user interface 226, displays a transmit button, such as transmit button 230 of FIG. 2A, to initiate a transmission. For example, a user may press the transmit button to transmit a video to the second electronic device. In an alternative embodiment, the processor of the first electronic device transmits the data in the common share area to a server, service, and/or the like.

At 318, previously and currently transmitted data associated with the contact in the common share area are displayed. In an example embodiment, the common share area allows a user to browse the transferred data associated with the contact in the common share area. For example, a user views all videos previously and currently transferred to a friend.

At 320, it is determined whether data is to be received. The first electronic device may receive data from the second electronic device. If at 320, it is determined that data is to be received, then at 325 the data is received. In an example embodiment, the first electronic device is configured to receive the data from the second electronic device. For example, the first electronic device receives an image of an automobile from the second electronic device.

At 330, the received data is displayed. In an example embodiment, a user interface of the first electronic device is configured to display the data in the common share area. A user of the first electronic device may view the image, e.g., received data, of the automobile. In an example embodiment, the user interface is configured to display the received data in at least one of the following views: a chronological view, a data view, a chat view, and/or the like.

If at 320, it is determined that no data is to be received, the example method 300 ends.

FIG. 3B is a flow diagram depicting another example method 350 for transmitting and receiving data in accordance with an example embodiment of the invention. Example method 350 may be performed by an electronic device, such as electronic device 250 of FIG. 2A.

At 352, it is determined whether a connection is to be established. In an example embodiment, a first electronic device, such as electronic device 205 of FIG. 2A, and a second electronic device, such as electronic device 250 of FIG. 2A, establish a connection if an active connection between the electronic devices does not already exist.

If at 352 it is determined that a connection is to be established, then at 355 a connection is established. In an example embodiment, the first electronic device and the second electronic device establish a connection. In an embodiment, the connection is at least one of the following: a voice call, an instant message, a voice over Internet protocol call, a short message service, multimedia messaging service, and/or the like. In an embodiment, the first electronic device and/or the second electronic device establish the connection via a network, such as Internet 245 of FIG. 2A. The example method 350 continues at 360.

If at 352, it is determined that a connection is not to be established, the example method 350 continues at 360.

At 360, data is received. In an example embodiment, the second electronic device is configured to receive the data from the first electronic device. For example, the second electronic device receives a camera feed from the first electronic device.

At 365, the received data is displayed. In an example embodiment, a user interface, such as user interface 270 of FIG. 2A, of the second electronic device is configured to display the data in the common share area. For example, the user interface displays the received data, e.g., camera feed, on the second electronic device. In an example embodiment, the user interface is configured to display the received data in at least one of the following views: a chronological view, a data view, a chat view, and/or the like.

At 370, it is determined whether data to be transmitted is selected. In an example embodiment, a processor, such as processor 272 of FIG. 2A, determines if data, such as data 278 of FIG. 2A, has been selected, e.g., received in a common share area, such as common share area 282 of FIG. 2A. For example, a user drags the data from, for example, a data browse, such as data browse 255 of FIG. 2A, to the common share area. In an embodiment, the data comprises one or more types of data.

If at 370, it is determined that data is selected, then at 375 the selected data is received in the common share area. In an example embodiment, the common share area is configured to receive selected data from the data browse. A user, for example, drags an image form the data browse to the common share area.

At 380, the selected data is transmitted. In an example embodiment, the processor of the second electronic device transmits the selected data in the common share area to the first electronic device. In an alternative embodiment, the processor transmits the data in the common share area to a server, service, a different electronic device, and/or the like. In an embodiment, a user interface, such as user interface 270 displays a transmit button, such as transmit button 260 of FIG. 2A. A user, for example, presses the transmit button to transmit the camera feed to the first electronic device.

At 385, previously and currently transmitted data associated with the contact in the common share area are displayed. In an example embodiment, the common share area allows a user to browse the transferred data associated with the contact in the common share area. For example, a user views all videos previously and currently transferred to a friend.

If at 370, it is determined that no data is selected, then the example method 350 ends.

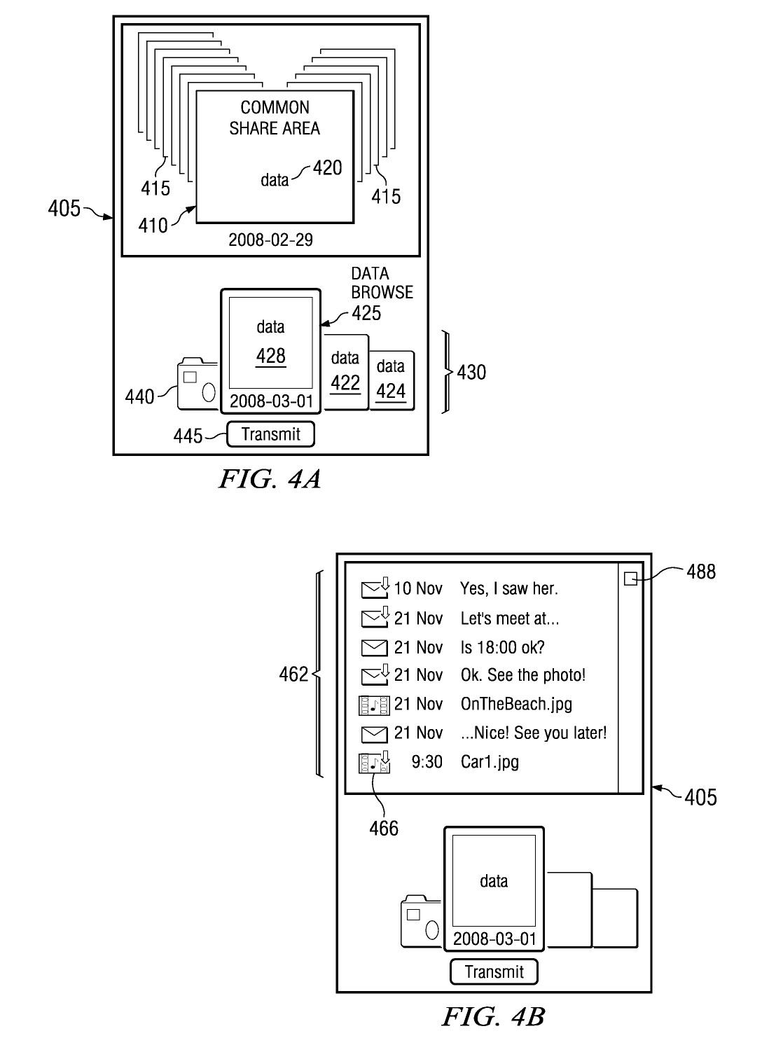

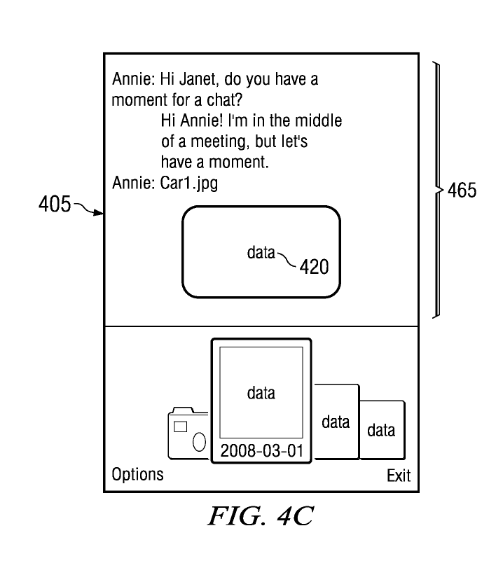

FIG. 4A an electronic device sharing a data view of data in accordance with an example embodiment of the invention. In an example embodiment, an electronic device 405 comprises a common share area 410, one or more tabs 415, a data browse 425, a data collection 430, a camera feed 440, a transmit button 445, and/or the like.

In an example embodiment, the electronic device 405 displays data 428 from the data collection 430 in the data browse 425. In an embodiment, the data browse 425 displays data 428 and/or other selectable data, such as data 422, 424. For example, a user of the data browse 425 browses the data collection 430. The data 428 may be selected, for example, by dragging data 428, into the common share area 410.

In an alternative embodiment, the electronic device 405 displays the camera feed 440. In an embodiment, a user of the data browse 425 selects the camera feed 440. The camera feed 440 may be selected, for example, by dragging the camera feed 440 into the common share area 410. In an alternative embodiment, the camera feed is selected, for example, by clicking on the camera feed 440.

In an example embodiment, the camera feed 440 is used, for example, to capture an image. In such a case, the image may be displayed as data 428 in the data browse 425. In an embodiment, a user, for example, drags the captured image, e.g., data 428, into the common share area 410.

In an example embodiment, the electronic device 405 displays a transmit button 445. In an embodiment, a user of the electronic device 405, for example, presses the transmit button 445 to transmit the camera feed 440 or data 428 to another electronic device, server, service, and/or the like. It should be understood that the electronic device 405 may be configured to display multiple data.

In an example embodiment, the electronic device 405 is configured to receive data 420 from another electronic device, server, service, and/or the like. The electronic device 405 may receive an image, e.g., data 420, of an automobile from another electronic device.

In an example embodiment, a user interface of the electronic device 405 is configured to display the data 420 in the common share area 410. For example, a user of the electronic device 405 views in the data view the received image, e.g., received data 420. In an example embodiment, the user interface displays one or more tabs 415 for additional data in the common share area 410. In an embodiment, the electronic device 405 allows a user to view other data 420 by selecting the one or more tabs 415.

FIG. 4B depicts an electronic device 405 sharing a chronological view of data in accordance with an example embodiment of the invention. In an example embodiment, a user interface, such as user interface 226 of FIG. 2A, is configured to display the data 462 in a chronological view. In an embodiment, the chronological view allows a user to view data 462 in the order of receipt. Further, the electronic device 405 is configured to expand a particular data item 466, such as an automobile image, to view in a more detailed view. For example, a user of the electronic device 405 clicks on data item 466 and the image of the automobile is displayed.

In an embodiment, the chronological view is further configured to scroll the display of the data 462 using, for example, scroll 488. In an embodiment, the scroll 488 is designed as a long rectangular area on one or two sides of the viewing area, comprising a bar or the like. In an embodiment, the bar is dragged along a track to move the body of the data 462 towards either end of the viewing area.

FIG. 4C depicts an electronic device sharing a chat view of data in accordance with an example embodiment of the invention. In an example embodiment, a user interface, such as user interface 226 of FIG. 2A, is configured to display the data 465 in a chat view. In an embodiment, the electronic device 405 is also configured to display an audio file, a live audio feed, a document, a text message, a video file, a live video feed, and/or the like. Further, the chat view may allow a user to view data 465 and a chat conversation, for example, with a user of another electronic device in real time. A possible technical effect of one or more of the example embodiments disclosed herein is communicating with one or more users in real time using different types of data.

In an embodiment, the chat view is further configured to scroll the display of the data 465 using, for example, scroll 488 of FIG. 4B. In an embodiment, the scroll is designed as a long rectangular area on one or two sides of the viewing area, comprising a bar or the like. In an embodiment, the bar is dragged along a track to move the body of the data 465 towards either end of the viewing area.

Without in any way limiting the scope, interpretation, or application of the claims appearing below, it is possible that a technical effect of one or more of the example embodiments disclosed herein may be viewing previous and current data transfers for a contact. Another possible technical effect of one or more of the example embodiments disclosed herein may be communicating with one or more users in real time using different types of data.

Embodiments of the present invention may be implemented in software, hardware, application logic or a combination of software, hardware and application logic. The software, application logic and/or hardware may reside on an electronic device, a server, or a service. If desired, part of the software, application logic and/or hardware may reside on electronic device, part of the software, application logic and/or hardware may reside on server, and part of the software, application logic and/or hardware may reside on service. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
allowing selection of data from a data browse using the common share area;
receiving the selected data in the common share area;
transmitting the selected data from the common share area to a contact; and
displaying previously and currently transmitted data associated with the contact in the common share area.

2. The method of claim 1 further comprising switching the data to be displayed in the data browse.

3. The method of claim 1 further comprising establishing a connection.

4. The method of claim 3 wherein the connection is at least one of the following: a voice call, an instant message, a voice over Internet protocol call, a short message service, or a multimedia messaging service.

5. The method of claim 1 wherein the data relates to at least one of the following: an audio file, a live audio feed, a document, a text message, a video file, or a live video feed, a single character, a musical note.

6. The method of claim 1 further comprising receiving data from an electronic device, server, or service.

7. The method of claim 6 further comprising displaying the received data in at least one of the following views: a chronological view, a data view, or a chat view.

8. The method of claim 1 wherein the common share area is capable of receiving at least one of the following: an audio file, a live audio feed, a document, a text message, a video file, or a live video feed.

9. An apparatus, comprising:
a data browse configured to display data;
a common share area configured to receive data;
a processor configured to:
allow selection of data from the data browse using the common share area;
the common share area configured to receive the selected data;
the processor configured to transmit the selected data from the common share area to a contact; and
the common share area configured to display previously and currently transmitted data associated with the contact.

10. The apparatus of claim 9 wherein the data browse is further configured to switch the data to be displayed.

11. The apparatus of claim 9 wherein the processor is further configured to establish a connection.

12. The apparatus of claim 11 wherein the connection is at least one of the following: a voice call, an instant message, a voice over Internet protocol call, a short message service, or a multimedia messaging service.

13. The apparatus of claim 9 further comprising an existing connection with the contact.

14. The apparatus of claim 9 wherein the data relates to at least one of the following: an audio file, a live audio feed, a document, a text message, a video file, or a live video feed.

15. The apparatus of claim 9 wherein the processor is further configured to receive data from an electronic device, server, or service.

16. The apparatus of claim 15 further comprising a user interface configured to display the received data in at least one of the following views: a chronological view, a data view, or a chat view.

17. The apparatus of claim 9 wherein the common share area is further configured to receive at least one of the following: an audio file, a live audio feed, a document, a text message, a video file, or a live video feed.

18. The apparatus of claim 9 wherein the processor comprises at least one memory that contains executable instructions that if executed by the processor cause the apparatus to: allow selection of data using a common share area, the data having one or more types of data; and transmit the selected data.

19. A computer program product comprising a computer-readable medium bearing computer program code embodied therein for use with a computer, the computer program code comprising:
code for allowing selection of data from a data browse using the common share area;
code for receiving the selected data in the common share area;
code for transmitting the selected data from the common share area to a contact; and
code for displaying previously and currently transmitted data associated with the contact in the common share area.

20-26. (canceled)
